(19) United States
(12) Patent Application Publication
(10) Pub. No.: US 2022/0263070 A1
(43) Pub. Date: Aug. 18, 2022

(54) SOLID-STATE MEDIUM FOR LITHIUM ION TRANSPORT, LITHIUM BATTERIES AND MANUFACTURING METHOD

(71) Applicant: Global Graphene Group, Inc., Dayton, OH (US)

(72) Inventors: Hui He, Dayton, OH (US); Bor Z. Jang, Centerville, OH (US)

(21) Appl. No.: 17/175,954

(22) Filed: Feb. 15, 2021

(51) Int. Cl. H01M 4/36; H01M 4/133; H01M 4/134; H01M 4/131; H01M 4/525; H01M 4/505; H01M 4/60; H01M 4/58; H01M 4/38; H01M 4/66; H01M 4/1393; H01M 10/0525

(52) U.S. Cl. CPC H01M 4/366; H01M 4/133; H01M 4/134; H01M 4/131; H01M 4/525; H01M 10/0525; H01M 4/606; H01M 4/58; H01M 4/386; H01M 4/661; H01M 4/1393; H01M 4/505

(57) ABSTRACT

A rechargeable lithium battery comprising an anode, a cathode, a lithium-ion permeable and electrically insulating separator, and a solid-state lithium ion-transporting medium, wherein the lithium ion-transporting medium and particles of a cathode active material are combined to form a cathode active material composite layer optionally supported by a cathode current collector; wherein the cathode active material occupies at least 75% (preferably from 80% to 95%) by weight or by volume of the cathode composite layer (not counting the cathode current collector weight or volume); the first lithium ion-transporting medium comprises a material selected from graphite, graphene, carbon, a sulfonated conducting polymer, a phthalocyanine compound, an organic or organometallic cathode active material, or a combination thereof; and the first medium constitutes a 3D network of both lithium ion-conducting paths and electron-conducting paths in the cathode.

### FIELD

The present disclosure provides a lithium battery (lithium-ion or lithium metal battery) containing a solid-state lithium ion-transporting medium that replaces the conventional liquid electrolyte or solid electrolyte.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the electrolytes used for lithium-ion batteries and all lithium metal secondary batteries pose some safety concerns. Most of the organic liquid electrolytes can cause thermal runaway or explosion problems.

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li-S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Furthermore, ILs remain extremely expensive. Consequently, as of today, no commercially available lithium battery makes use of an ionic liquid as the primary electrolyte component.

Solid state electrolytes are commonly believed to be safe in terms of fire and explosion resistance. Solid state electrolytes can be divided into organic, inorganic, organic-inorganic composite electrolytes.

However, the conductivity of conventional polymer solid state electrolytes, such as poly(ethylene oxide) (PEO), polypropylene oxide (PPO), poly(ethylene glycol) (PEG), and poly(acrylonitrile) (PAN), is typically low (<10⁻⁵S/cm).

Although the inorganic solid-state electrolyte (e.g., garnet-type and metal sulfide-type) can exhibit a high conductivity (up to about 10⁻³S/cm, but mostly <10⁻⁴ S/cm), the interfacial impedance or resistance between the inorganic solid-state electrolyte and the electrode (cathode or anode) is high. The sulfide-based solid electrolytes generally show high ionic conductivity and mechanically adaptable interface with high deformability, but their limited electrochemical stability and high chemical reactivity with polar components must be circumvented with additional electrochemical treatments. On the other hand, the oxide-based solid electrolytes have superior electrochemical stability, but relatively low ionic conductivity and low processability owing to their mechanical rigidity and brittleness. These materials cannot be cost-effectively manufactured. Although an organic-inorganic composite electrolyte can lead to a reduced interfacial resistance, the lithium ion conductivity and working voltages may be decreased due to the addition of the organic polymer.

All-solid-state batteries are believed to be capable of realizing ultimate safety and superior energy density. The use of solid electrolytes is essential to enabling such outstanding features, instead of liquid electrolytes employed in conventional lithium-ion batteries. In this regard, the development of solid electrolytes with superior electrochemical properties is highly desirable.

The solid electrolyte is normally utilized in two parts in the all-solid-state batteries. First, the separator layer between the cathode and the anode is fabricated from particles of a solid electrolyte powder for providing efficient lithium-ion transport between the two electrodes while electrically isolating the anode and the cathode. This solid-electrolyte separator is typically prepared by cold-pressing of solid electrolyte particles with/without polymeric binder/scaffold or by sintering of solid electrolyte particles in close contact at high temperature. Second, the solid electrolyte is mixed with an anode active material to form a composite electrode, essentially mimicking the porous electrode in lithium-ion batteries that use liquid electrolyte. In conventional lithium-ion batteries, a liquid electrolyte permeates and fills the pores within an electrode, thereby facilitating the lithium-ion transport within the electrode. However, this is difficult to realize in the all-solid-state batteries. Thus, for the production of an all-solid-state electrode, ionic transport media must be established to facilitate facile ion migration to the active material. In this context, an efficient spatial arrangement of the solid electrolyte within the electrode is vital, and various stringent mixing protocols and intricate particle size control of solid electrolytes/active materials must be followed.

Unfortunately, previous approaches to incorporating a solid-state electrolyte into an electrode (particularly the cathode) typically have resulted in a low proportion of the cathode active material (e.g., up to only 50-75% by weight or by volume of the cathode active material) and, hence, a low charge storage capacity of the battery per unit weight or volume.

Hence, a general object of the present disclosure is to provide a safe, flame/fire-resistant, solid-state lithium ion-transporting medium that replaces the conventional electrolyte for a rechargeable lithium cell, which is capable of storing a higher amount of charge per unit battery weight or volume. Such a medium must also have a high capability of transporting lithium ions at a relatively high rate. Such a medium must also be compatible with existing battery production processes and equipment.

### SUMMARY

The present disclosure provides a rechargeable lithium battery comprising an anode, a cathode, a lithium-ion permeable and electrically insulating separator that electrically separates the anode from the cathode, and a first solid-state lithium ion-transporting medium, wherein (i) the first lithium ion-transporting medium and particles of a first cathode active material are combined to form a cathode active material composite layer optionally supported by a cathode current collector wherein the cathode active material occupies at least 75% (preferably and typically from 80% to 95%) by weight or by volume of the cathode composite layer, not counting the cathode current collector weight or volume; (ii) the first lithium ion-transporting medium comprises a material selected from graphite, graphene, carbon, a sulfonated conducting polymer, a phthalocyanine compound, an organic or organometallic cathode or anode active material, or a combination thereof, wherein the organic or organometallic cathode or anode active material is different in composition than the first cathode active material; and (iii) the first lithium ion-transporting medium constitutes a 3D network of both lithium ion-conducting paths and electron-conducting paths in the cathode.

It may be noted that some of these lithium ion-transporting medium materials, such as graphite, graphene, carbon (e.g., soft carbon, hard carbon, carbonized resin, amorphous carbon, physical vapor-deposited carbon, sputtering-deposited carbon, etc.) and sulfonated conducting polymers (intrinsically conducting conjugate polymers, such as polyaniline, polypyrrole, and polythiophene) are not the conventional electrolytes used in the lithium batteries. They have not been previously considered as electrolyte materials at all. We have discovered that these materials happen to be both ion-conducting and electron-conducting when implemented in the cathode or the anode.

The phthalocyanine compounds and the organic or organometallic cathode active materials have never been previously used as an electrolyte or a lithium ion-transporting medium possibly because they are not known to have a good lithium ion conductivity. We have surprisingly discovered that these organic or organometallic cathode active materials can be used to replace the conventional electrolytes to act as a lithium ion-transporting medium in a lithium battery. They are used herein in conjunction with carbon, graphite, graphene, or any other type of electrically conducting additive to provide dual networks of electron-conducting and ion-conducting pathways.

Preferably, the sulfonated conducting polymer comprises a sulfonated version of a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′, 7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a lithiated version thereof, or a combination thereof. In some preferred embodiments, the conducting polymer comprises polyaniline, polypyrrole, or polythiophene.

The phthalocyanine compound may be selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, a lithiated version thereof, or a combination thereof.

The organic or organometallic cathode or anode active material, herein serving as a lithium ion-transporting medium, may be selected from poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons),

Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, Na₄C₆O₆, Na₂C₆O₆, Na₆C₆O₆, tetralithium 1,2,4,5-benzenetetracarboxylate (Li₄C₁₀H₂O₈, Li₄BTC) salt, tetralithium salt of tetrahydroxybenzoquinone (denoted Li₄ -THQ), tetralithium salt of dihydroxyterephthalate (Li₄-p-DHT), Emodin (6-methyl1,3,8-trihydroxyanthraquinone), humic acid, dilithium salt of 2,5-(dianilino)terephthalate (denoted Li₂-DAnT), Poly (2,2,6,6-tetramethylpiperdinyloxy4-yl methacrylate) (PTMA), tetralithium 2,5-dihydroxy-1,4-benzenedisulfonate, di-lithium (2,3-dilithium oxy)-terephthalate (denoted Li₄ -o-DHT), dilithium terephthalate, conjugated dicarboxylate, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In certain embodiments, the cathode composite layer comprises (i) cathode active material particles that are individually encapsulated by the first lithium ion-transporting medium, (ii) particulates (or secondary particles) that each contain a plurality of cathode active material particles encapsulated by the first lithium ion-transporting medium, or both.

In certain embodiments, the cathode does not contain an additional conductive additive (e.g. carbon black, carbon nanotubes, etc.) that is different than the graphite, graphene, or carbon. Graphite, graphene, and carbon are electrically conducting.

In some embodiments, the cathode does not contain any conventional lithium battery electrolyte such as an inorganic solid electrolyte, a liquid electrolyte, a polymer gel electrolyte, or a solid polymer electrolyte. The first lithium ion-transporting medium per se is found to be capable of facilitating fast lithium ion transport through the medium or through the interface between the medium and a cathode or anode active material. This is evidenced by a high lithium ion conductivity and a low impedance in an electrode.

In some embodiments, the rechargeable lithium battery is a lithium-ion battery and the battery cell further comprises a second solid-state lithium ion-transporting medium in the anode, wherein the second lithium ion-transporting medium and particles of an anode active material are combined to form an anode active material composite layer optionally supported by an anode current collector, wherein the anode active material occupies at least 75% by weight or by volume (preferably from 80% to 95%) of the anode composite layer (not counting the anode current collector weight or volume); the second lithium ion-transporting medium comprises an ion-conducting and electron-conducting material selected from graphite, graphene, carbon, a sulfonated conducting polymer, a phthalocyanine compound, an organic or organometallic cathode or anode active material, or a combination thereof; and the second lithium ion-transporting medium constitutes a 3D network of both lithium ion-conducting paths and electron-conducting paths in the anode.

Preferably, the anode does not contain an additional conductive additive (such as carbon black, acetylene black, carbon nanotubes, and activated carbon) that is different than the graphite, graphene, or carbon (that is used as a lithium ion-transporting medium). Further, in some embodiments, the anode does not contain any conventional lithium battery electrolyte such as an inorganic solid electrolyte, a liquid electrolyte, a polymer gel electrolyte, or a solid polymer electrolyte.

In some embodiments, the first solid-state lithium ion-transporting medium further comprises a lithium salt dispersed therein. In certain embodiments, the second lithium ion-transporting medium further comprises a lithium salt dispersed therein. The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof. The lithium salt, up to 50% by weight, in the medium is found to increase the lithium ion conductivity of the solid-state lithium ion-transporting medium.

The first lithium ion-transporting medium may be the same as or different than the second lithium ion-transporting medium.

Still another preferred embodiment of the present disclosure is a rechargeable lithium-sulfur cell or lithium-ion sulfur cell containing a sulfur cathode having sulfur or lithium polysulfide as a cathode active material.

For a lithium metal cell (where lithium metal is the primary active anode material), the anode current collector may comprise a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

The first cathode active material preferably comprises an inorganic material selected from a metal oxide, metal phosphate, metal silicide, metal selenide, transition metal sulfide, or a combination thereof. The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

In certain preferred embodiments, the first cathode active material is selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In certain embodiments, the inorganic material comprises a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In some embodiments, the first cathode active material comprises an inorganic material selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1. The inorganic material may be selected from a transition metal dichalcogenide, a transition metal trichalcogenide, or a combination thereof. In some embodiments, the inorganic material is selected from TiS₂, TaS₂, MoS₂, NbSe₃, MnO₂, CoO₂, an iron oxide, a vanadium oxide, or a combination thereof. The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The disclosure further provides a method of producing a rechargeable lithium cell, the method comprising: (a) Preparing an anode, a cathode, a lithium-ion permeable and electrically insulating separator, wherein the cathode comprises a composite layer comprising coated particles of a first cathode active material, wherein the coated particles each comprise individual or a plurality of primary particles of the first cathode active material that are coated with or encapsulated by a first lithium ion-transporting medium comprising a material selected from graphite, graphene, carbon, a sulfonated conducting polymer, a phthalocyanine compound, an organic or organometallic cathode or anode active material, or a combination thereof, wherein the first lithium ion-transporting medium constitutes a 3D network of both lithium ion-conducting paths and electron-conducting paths in the cathode; and (b) combining the anode, the separator, the cathode, and a protective housing into the battery cell.

In certain embodiments, the anode comprises a composite layer comprising coated particles of an anode active material, wherein the coated particles each comprise individual or a plurality of anode active material primary particles that are coated with or encapsulated by a second lithium ion-transporting medium comprising a material selected from graphite, graphene, carbon, a sulfonated conducting polymer, a phthalocyanine compound, an organic or organometallic cathode active material, or a combination thereof, wherein the second lithium ion-transporting medium constitutes a 3D network of both lithium ion-conducting paths and electron-conducting paths in the anode.

These and other advantages and features of the present disclosure will become more transparent with the description of the following best mode practice and illustrative examples.

### BRIEF DESCRIPTION OF THE DRAWINGS

FIG. 1(A) Methods of encapsulating primary particles of a cathode or anode active material with a lithium ion-transporting medium according to certain embodiments of the present disclosure;

FIG. 1(B) Schematic of an electrode comprising ion-transporting medium-encapsulated active material particles packed together according to certain embodiments of the present

FIG. 1(C) Schematic of an electrode comprising active material particles embedded in a matrix (continuous phase) of a lithium ion-transporting medium, which is also electron-conducting.

FIG. 1(D) A process flow chart to illustrate a method of producing graphene-encapsulated particles using ball milling.

FIG. 2(A) Structure of an anode-less lithium metal cell (as manufactured or in a discharged state) according to some embodiments of the present disclosure;

FIG. 2(B) Structure of an anode-less lithium metal cell (in a charged state) according to some embodiments of the present disclosure.

### DETAILED DESCRIPTION

The present disclosure provides a safe and high-performing lithium battery, which can be any of various types of lithium-ion cells or lithium metal cells. A high degree of safety is imparted to this battery by a novel and unique lithium ion-transporting medium, in place of the conventional electrolyte. This medium is highly flame-resistant and would not initiate a fire or sustain a fire and, hence, would not pose explosion danger. This disclosure has solved the very most critical issue that has plagued the lithium-metal and lithium-ion industries for more than two decades.

The present disclosure provides a rechargeable lithium battery comprising an anode, a cathode, a lithium-ion permeable and electrically insulating separator that electrically separates the anode from the cathode, and a first solid-state lithium ion-transporting medium, wherein (i) the first lithium ion-transporting medium and particles of a first cathode active material are combined to form a cathode active material composite layer optionally supported by a cathode current collector wherein the cathode active material occupies at least 75% (preferably from 80% to 95%) by weight or by volume of the cathode composite layer, not counting the cathode current collector weight or volume; (ii) the first lithium ion-transporting medium comprises a material selected from graphite, graphene, carbon, a sulfonated conducting polymer, a phthalocyanine compound, an organic or organometallic cathode active material, or a combination thereof, wherein the organic or organometallic cathode active material is different in composition than the first cathode active material; and (iii) the first lithium ion-transporting medium constitutes dual 3D networks of both lithium ion-conducting paths and electron-conducting paths in the cathode

It may be noted that some of these lithium ion-transporting medium materials, such as graphite, graphene, carbon (e.g., soft carbon, hard carbon, carbonized resin, amorphous carbon, physical vapor-deposited carbon, sputtering-deposited carbon, etc.) and sulfonated conducting polymers (sulfonated derivatives of intrinsically conducting conjugate polymers, such as polyaniline, polypyrrole, and polythiophene) are not the conventional electrolytes used in the lithium batteries. They are not considered as electrolyte materials at all. We have unexpectedly discovered that these materials happen to be both ion-conducting and electron-conducting when implemented in combination with particles of an anode active material or cathode active material.

The phthalocyanine compounds and the organic or organometallic cathode active materials have never been previously used as an electrolyte or a lithium ion-transporting medium since they are not known to have a good lithium ion conductivity. We have surprisingly discovered that these organic or organometallic cathode active materials can be used to replace the conventional electrolytes to act as a lithium ion-transporting medium in a lithium battery. They are used herein in conjunction with carbon, graphite, graphene, or any other type of electrically conducting additive to provide dual networks of electron-conducting and ion-conducting pathways.

Graphite used as a lithium ion-transporting medium may be selected from natural graphite, artificial graphite, expanded graphite flakes, exfoliated graphite worms, etc. Carbon may be selected from soft carbon, hard carbon, carbonized resin, amorphous carbon, physical vapor-deposited carbon, sputtering-deposited carbon, etc. Graphene may be selected from pristine graphene, graphene oxide (including reduced graphene oxide, RGO), halogenated graphene (including graphene fluoride), nitrogenated graphene, hydrogenated graphene, chemically functionalized graphene, and doped graphene, etc. The production of these materials is well known in the art. All these materials are widely available from commercial sources.

Preferably, the sulfonated conducting polymer comprises a sulfonated version of a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′, 7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a lithiated version thereof, or a combination thereof. In some preferred embodiments, the conducting polymer comprises polyaniline, polypyrrole, or polythiophene.

The phthalocyanine compound may be selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, a lithiated version thereof, or a combination thereof.

The organic or organometallic cathode or anode active material refers to an organic or organometallic cathode active material capable of storing lithium of at least 10 mAh/g, preferably and typically at least 50 mAh/g (typically from 100 to 650 mAh/g). The organic or organometallic cathode active material, herein serving as a lithium ion-transporting medium, may be selected from poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-B enzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, Na₄C₆O₆, Na₂C₆O₆, Na₆C₆O₆, tetralithium 1,2,4,5 benzenetetracarboxylate (Li₄C₁₀H₂O₈, Li₄BTC) salt, tetralithium salt of tetrahydroxybenzoquinone (denoted Li₄ -THQ), tetralithium salt of dihydroxyterephthalate (Li₄ -p-DHT), Emodin (6-methyl1,3,8-trihydroxyanthraquinone), humic acid, dilithium salt of 2,5-(dianilino)terephthalate (denoted Li₂-DAnT), Poly (2,2,6,6-tetramethylpiperdinyloxy4-yl methacrylate) (PTMA), tetralithium 2,5-dihydroxy-1,4-benzenedisulfonate, di-lithium (2,3-dilithium oxy)-terephthalate (denoted Li₄ -o-DHT), dilithium terephthalate (e.g., dilithium 2,5-dihydroxyterephthalate, Li₂DHTP), conjugated dicarboxylate, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

The rechargeable lithium battery may be a lithium-ion battery and the battery cell further comprises a second solid-state lithium ion-transporting medium in the anode, wherein the second lithium ion-transporting medium and particles of an anode active material are combined to form an anode active material composite layer optionally supported by an anode current collector, wherein the anode active material occupies at least 75% by weight or by volume (preferably from 80% to 95%) of the anode composite layer (not counting the anode current collector weight or volume); the second lithium ion-transporting medium comprises an ion-conducting and electron-conducting material selected from graphite, graphene, carbon, a sulfonated conducting polymer, a phthalocyanine compound, an organic or organometallic cathode or anode active material, or a combination thereof; and the second lithium ion-transporting medium constitutes a 3D network of both lithium ion-conducting paths and electron-conducting paths in the anode.

Preferably, the anode does not contain an additional conductive additive (such as carbon black, acetylene black, carbon nanotubes, and activated carbon) that is different than the graphite, graphene, or carbon (that is used as a lithium ion-transporting medium). Further, in some embodiments, the anode does not contain any conventional lithium battery electrolyte such as an inorganic solid electrolyte, a liquid electrolyte, a polymer gel electrolyte, or a solid polymer electrolyte.

In some embodiments, the first lithium ion-transporting medium further comprises a lithium salt dispersed therein. In certain embodiments, the second lithium ion-transporting medium further comprises a lithium salt dispersed therein. The first or the second lithium ion-transporting medium preferably does not contain any liquid solvent. The first lithium ion-transporting medium may be the same as or different than the second lithium ion-transporting medium.

As indicated earlier in the Background section, previous approaches to incorporating a solid-state electrolyte into an electrode (particularly the cathode) typically have resulted in a low proportion of the cathode active material (e.g., up to only 50-75% by weight or by volume of the cathode active material in the cathode composite layer, not counting the current collector weight or volume) and, hence, a low charge storage capacity of the battery per unit weight or volume.

There are 25%-50% of the materials in the cathode composite layer that are not active material; not capable of storing/releasing lithium during the battery discharge/charge cycles. This problem is serious since the cathode active materials have relatively lithium ion storage capacity as compared to the anode and, unfortunately, the required amount of lithium ions are typically stored in the cathode when a lithium-ion battery is made.

The presently disclosed strategy of implementing a lithium ion-transporting medium to build dual networks of lithium ion-conducting pathways and electron-conducting pathways obviates the need to incorporate large proportions of non-active materials (such as electrolyte, conducting additive, and/or binder) in an electrode (anode or cathode). In fact, in most of the situations, there is no need to have any of these conventional electrolyte, conductive additive, and binder materials in the electrode although one may choose to add some small amount of these materials for certain purposes as desired. A reduced proportion of non-active materials implies a higher energy density (higher amount of energy stored per unit mass or volume of the battery). For electrical vehicle applications, this implies a longer driving range on one battery charge.

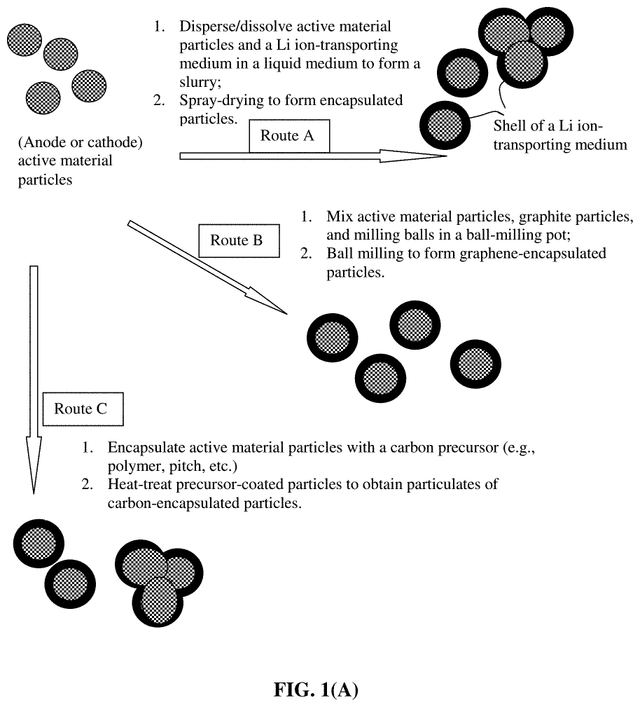

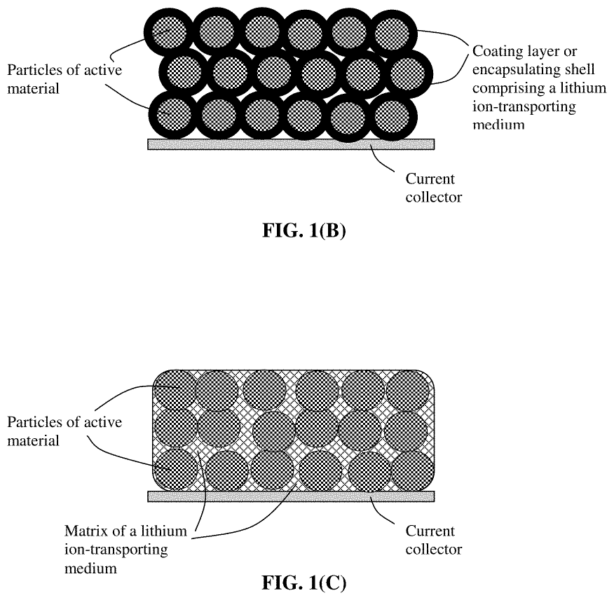

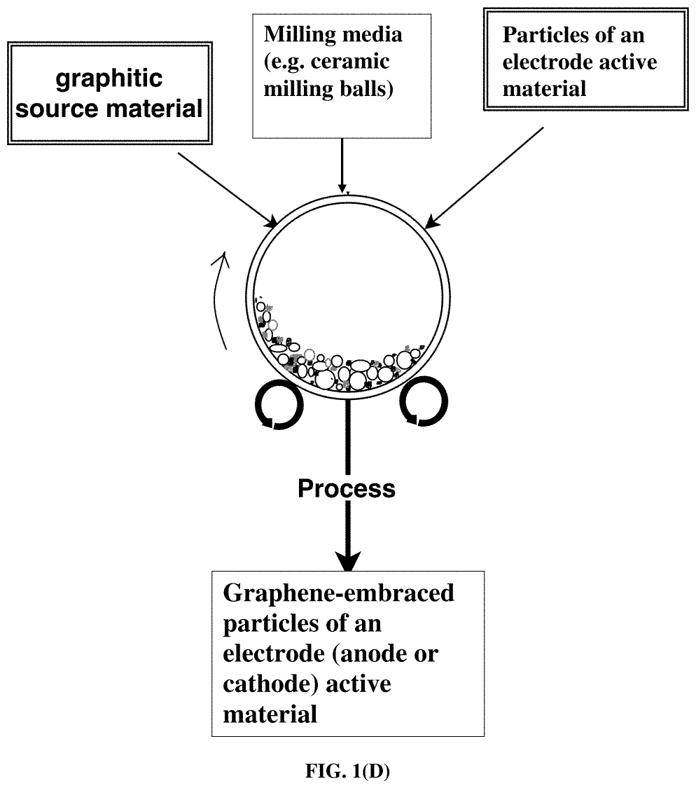

There are many ways to build dual networks of ion-conducting and electron-conducting pathways in an anode or cathode. According to some embodiments of the present disclosure, a convenient and effective way is to first coat or encapsulate active material particles (e.g., Si particles in the anode or LiCoO₂ in the cathode) with a presently disclosed lithium ion-transporting medium. This is followed by packing these coated/encapsulated particles (or particulates) to form a composite electrode, as illustrated in FIG. 1(B) which indicates that the lithium ion-transporting medium on surfaces of the active material particles forms a network of 3D connected or continuous pathways. The medium (if graphite, carbon, or graphene per se) may be both electron- and ion-conducting. The graphite-, carbon-, or graphene-encapsulated active material particles may require from 2% to 7% of a resin binder to help hold these particles together. The phthalocyanine compound or organic or organometallic cathode active material is lithium ion-conducting and can become electron-conducting if combined with carbon, graphite, graphene, or other conducting material (1-8%, preferably lower than 5%).

In another possible configuration, as illustrated in FIG. 1(C), the cathode (or anode) active material particles are dispersed or embedded in a matrix of the lithium ion-transporting medium (e.g. organic cathode or anode active material). Typically, an organic (including polymeric) cathode or anode active material is dissolvable in a liquid solvent or can be melted into a liquid state. Particles of the first cathode active material (e.g. inorganic LiCoO₂) can be readily dispersed in an organic matrix using known processes.

There are several methods of coating/encapsulating the primary particles of an anode or cathode active material with/by a lithium ion-transporting medium; three examples are illustrated in FIG. 1(A). One method, Route A, entails dispersing or dissolving active material particles and a Li ion-transporting medium (e.g., graphene oxide sheets, expanded graphite flakes, or an organic cathode active material) in a liquid medium to form a slurry, which is followed by spray-drying to form encapsulated particles. Spray-drying is but one of the many well-known methods of encapsulating particles with an encapsulating shell. Other methods such as pan coating, fluidized-bed coating, and vibration nozzle coating will be further discussed later. Route C entails encapsulating primary particles of an active material with a carbon precursor (e.g., a polymer, petroleum pitch, etc.), followed by thermally converting the carbon precursor to carbon. Such a carbonization procedure typically is conducted by heat-treating the precursor at a temperature from 300° C. to 1,500° C. for 1-10 hours.

Route B involves mixing solid active material particles, graphite particles, and milling balls in a ball-milling pot, which is followed by ball milling to form graphene-encapsulated particles. As schematically illustrated in FIG. 1(D), one preferred embodiment of this method entails placing particles of a source graphitic material, particles of a solid electrode active material, and impacting balls (particles of ball-milling media) in an energy impacting chamber. After loading, the resulting mixture is exposed to impacting energy, which is accomplished, for instance, by rotating the chamber to enable the impacting of the milling balls against graphite particles. These repeated impacting events (occurring in high frequencies and high intensity) act to peel off graphene sheets from the surfaces of graphitic material particles and tentatively transferred to the surfaces of these impacting balls first. When the graphene-coated impacting balls subsequently impinge upon the solid electrode active material particles, the graphene sheets are transferred to surfaces of the electrode active material particles to form graphene-coated active material particles. Typically, the entire particle is covered by graphene sheets (fully wrapped around, embraced or encapsulated). Subsequently, the externally added impacting balls (e.g. ball-milling media) are separated from the graphene-embraced particles.

The particles of ball-milling media may contain milling balls selected from ceramic particles (e.g. ZrO₂ or non-ZrO₂-based metal oxide particles), metal particles, glass particles, or a combination thereof. In less than two hours (often less than 1 hour) of operating the direct transfer process, most of the constituent graphene sheets of source graphite particles are peeled off, forming mostly single-layer graphene and few-layer graphene (mostly less than 5 layers or 5 graphene planes). Following the transfer process (graphene sheets wrapped around active material particles), the residual graphite particles (if present) are separated from the graphene-embraced (graphene-encapsulated) particles using a broad array of methods. Separation or classification of graphene-embraced (graphene-encapsulated) particles from residual graphite particles (if any) can be readily accomplished based on their differences in weight or density, particle sizes, magnetic properties, etc. The ball milling products are graphene-embraced particles.

In other words, production of graphene sheets and coating graphene sheets on particles of an electrode active material are essentially accomplished concurrently in one operation. This is in stark contrast to the traditional processes of producing graphene sheets first and then subsequently mixing the graphene sheets with an active material.

The energy impacting apparatus is a vibratory ball mill, planetary ball mill, high energy mill, basket mill, agitator ball mill, cryogenic ball mill, micro ball mill, tumbler ball mill, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer

There are three broad categories of micro-encapsulation methods that can be implemented to produce polymer-, organic material-, expanded graphite-, and graphene sheet-encapsulated particles of an anode active material: physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling the active material particles in a pan or a similar device while the encapsulating material (e.g. monomer/oligomer, organic melt, polymer/solvent solution, graphene sheet/liquid suspension, etc.) is applied slowly until a desired encapsulating shell thickness is attained.

Air-suspension coating method: In the air suspension coating process, the solid particles (core material) are dispersed into the supporting air stream in an encapsulating chamber. A controlled stream of a polymer-solvent solution (monomer/oligomer, organic melt, polymer/solvent solution, graphene sheet/liquid suspension, etc.) is concurrently introduced into this chamber, allowing the solution to hit and coat the suspended particles. These suspended particles are encapsulated (fully coated) with polymer (or organic material, graphene sheets, etc.) while the volatile solvent is removed, leaving a very thin layer of polymer (monomer/oligomer, organic melt, polymer/solvent solution, graphene sheet/liquid suspension, etc.) on surfaces of these particles. This process may be repeated several times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Anode or cathode active materials may be encapsulated using a rotating extrusion head containing concentric nozzles. In this process, a stream of core fluid (slurry containing particles of an active material dispersed in a solvent) is surrounded by a sheath of shell solution or melt. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry.

Vibrational nozzle method: Core-shell encapsulation or matrix-encapsulation of an active material can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the anode active material. The solidification can be done according to the used gelation system with an internal gelation (e.g. sol-gel processing, melt) or an external (additional binder system, e.g. in a slurry).

Spray-drying: Spray drying may be used to encapsulate particles of an active material when the active material is dissolved or suspended in a melt or polymer solution. In spray drying, the liquid feed (solution or suspension) is atomized to form droplets which, upon contacts with hot gas, allow solvent to get vaporized and thin polymer shell to fully embrace the solid particles of the active material.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A solution of the active material and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical groups to form an elastomer shell material.

In-situ polymerization: In some micro-encapsulation processes, active materials particles are fully coated with a monomer or oligomer first. Then, direct polymerization of the monomer or oligomer is carried out on the surfaces of these material particles.

Matrix polymerization: This method involves dispersing and embedding a core material in a polymeric matrix during formation of the particles. This can be accomplished via spray-drying, in which the particles are formed by evaporation of the solvent from the matrix material. Another possible route is the notion that the solidification of the matrix is caused by a chemical change.

The disclosed lithium battery can be a lithium-ion battery or a lithium metal battery, the latter having lithium metal as the primary anode active material. The lithium metal battery can have lithium metal implemented at the anode when the cell is made. Alternatively, the lithium may be stored in the cathode active material and the anode side is lithium metal-free initially. This is called an anode-less lithium metal battery.

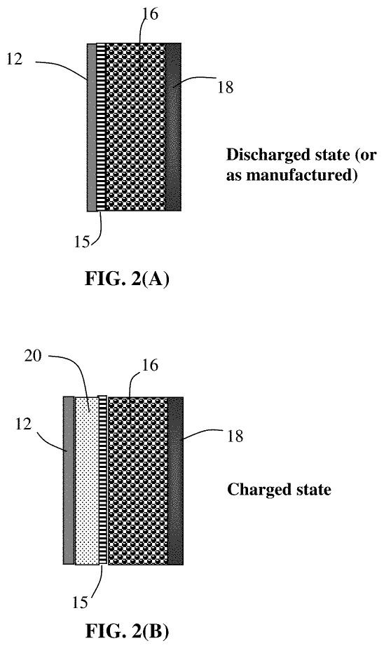

As illustrated in FIG. 2(A), the anode-less lithium cell is in an as-manufactured or fully discharged state according to certain embodiments of the present disclosure. The cell comprises an anode current collector 12 (e.g., Cu foil), a separator, a cathode layer 16 comprising a cathode active material, an optional conductive additive (not shown), an optional resin binder (not shown), and an electrolyte (dispersed in the entire cathode layer and in contact with the cathode active material), and a cathode current collector 18 that supports the cathode layer 16. There is no lithium metal in the anode side when the cell is manufactured.

In a charged state, as illustrated in FIG. 2(B), the cell comprises an anode current collector 12, lithium metal 20 plated on a surface (or two surfaces) of the anode current collector 12 (e.g., Cu foil), a separator 15, a cathode layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector.

One unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode only contains a current collector or a protected current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities should be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may comprise graphene balls and/or graphene foam. Preferably, the graphene layer has a thickness from 1 nm to 50 μm and/or has a specific surface area from 5 to 1000 m²/g (more preferably from 10 to 500 m²/g).

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

A highly significant observation is that the battery system does not contain any volatile electrolyte that can escape into the vapor phase. There are simply no flammable gas molecules from initiating a flame even at an extremely high temperature. The lithium ion-transporting solid just would not catch on fire. This is a highly significant discovery, considering the notion that fire and explosion concern has been a major impediment to widespread acceptance of battery-powered electric vehicles. This new technology could significantly impact the emergence of a vibrant EV industry.

In addition to the non-flammability and high lithium ion transference numbers, there are several additional benefits associated with using the presently disclosed solid-state medium for lithium ion transport. Due to a good contact between the medium and an electrode, the interfacial impedance can be significantly reduced.

As another benefit example, this solid-state medium is capable of inhibiting lithium polysulfide dissolution at the cathode and migration to the anode of a Li-S cell, thus overcoming the polysulfide shuttle phenomenon and allowing the cell capacity not to decay significantly with time. Consequently, a coulombic efficiency nearing 100% along with long cycle life can be achieved.

There is also no restriction on the type of the cathode materials that can be used in practicing the present disclosure. For Li-S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

The following examples are presented primarily for the purpose of illustrating the best mode practice of the present disclosure, not to be construed as limiting the scope of the present disclosure.

### EXAMPLE 1

### Graphene Encapsulated Particles of Cathode or Anode Active Materials

Several types of electrode active materials (both anode and cathode active materials) in a fine powder form were investigated. These include Co₃O₄, Si, LiCoO₂, LiMn₂O₄, lithium iron phosphate, etc., which are used as examples to illustrate the best mode of practice. These active materials were either prepared in house or purchased from commercial sources.

In a typical experiment, 1 kg of electrode active material powder and 100 grams of natural flake graphite, 50 mesh (average particle size 0.18 mm; Asbury Carbons, Asbury N.J.), and milling balls (stainless steel balls, ZrO₂ balls, glass balls, and MoO₂ balls, etc.) were placed in a high-energy ball mill container. The ball mill was operated at 300 rpm for 0.5 to 4 hours. The container lid was then removed and particles of the active materials were found to be fully coated (embraced or encapsulated) with a dark layer, which was verified to be graphene by Raman spectroscopy. The mass of processed material was placed over a 50 mesh sieve and, in some cases, a small amount of unprocessed flake graphite was removed.

Graphene-encapsulated particles of Co₃O₄ and Si were respectively compacted together and against a Cu foil surface to prepare an anode. Graphene-encapsulated particles of LiCoO₂, LiMn₂O₄, and lithium iron phosphate were respectively compacted together and against an Al foil surface to prepare a cathode. An anode, a porous separator, and a cathode were combined together and encased in a protective housing (laminated plastic/Al envelop) to form a battery cell.

### EXAMPLE 2

### Graphene-Embraced SnO₂ Particles

In an experiment, 2 grams of 99.9% purity tin oxide powder (90 nm diameter), 0.25 grams highly oriented pyrolytic graphite (HOPG), and 1 gram of ZrO₂ balls were placed in a resonant acoustic mill and processed for 5 minutes. For comparison, the same experiment was conducted, but without the presence of zirconia milling beads. The direct transfer process (tin oxide particles serving as the milling media per se without the externally added zirconia milling beads) led to mostly single-particle particulate (each particulate contains one particle encapsulated by graphene sheets). In contrast, with the presence of externally added milling beads, a graphene-embraced particulate tends to contain some multiple tin oxide particles (typically 3-50) wrapped around by graphene sheets. These same results were also observed for most of metal oxide-based electrode active materials (both anode and cathode).

### EXAMPLE 3

### Graphene-Encapsulated and Carbon-Encapsulated Si Micron Particles

In a first experiment, 500 g of Si powder (particle diameter ˜3 μm), 50 grams of highly oriented pyrolytic graphite (HOPG), and 100 grams of ZrO₂ balls were placed in a high-intensity ball mill. The mill was operated for 20 minutes, after which the container lid was opened and un-processed HOPG was removed by a 50 mesh sieve. The Si powder was coated with a dark layer, which was verified to be graphene by Raman spectroscopy.

In a second experiment, micron-scaled Si particles from the same batch were pre-coated with a layer of polyethylene (PE) using a micro-encapsulation method that includes preparing solution of PE dissolved in toluene, dispersing Si particles in this solution to form a slurry, and spry-drying the slurry to form PE-encapsulated Si particles. Some of these PE-encapsulated particles were subjected to a heat treatment (up to 600° C.) that converted PE to carbon, resulting in the formation of amorphous carbon-encapsulated Si particles.

Then, 500 g of PE-encapsulated Si particles and 50 grams of HOPG were placed in a high-intensity ball mill. The mill was operated for 20 minutes, after which the container lid was opened and un-processed HOPG was removed by a 50 mesh sieve. The PE-encapsulated Si particles (PE layer varied from 0.3 to 2.0 μm) were now also embraced with graphene sheets. These graphene-embraced PE-encapsulated particles were then subjected to a heat treatment (up to 600° C.) that converted PE to carbon. The converted carbon was mostly deposited on the exterior surface of the Si particles, leaving behind a gap or pores between the Si particle surface and the encapsulating graphene shell. This gap provides room to accommodate the volume expansion of the Si particle when the lithium-ion battery is charged. Such a strategy leads to significantly improved battery cycle life.

In a third experiment, the Si particles were subjected to electrochemical pre-lithiation to prepare several samples containing from 5% to 54% Li. Pre-lithiation of an electrode active material means the material is intercalated or loaded with lithium before a battery cell is made.

Various pre-lithiated Si particles were then subjected to the presently invented graphene encapsulation treatment. The resulting graphene-encapsulated prelithiated Si particles were incorporated as an anode active material in several lithium-ion cells.

### EXAMPLE 4

### Disodium Rhodizonate (Na₂C₆O₆)-Coated Graphene-Embraced NMC-532 Cathode active particles (using meso-carbon micro beads or MCMBs as the graphene source)

In one example, 500 grams of NMC-532 powder and 10 grams of MCMBs (China Steel Chemical Co., Taiwan) were placed in a ball mill (with or without milling balls), and processed for 3 hours. In separate experiments, un-processed MCMB was removed by sieving, air classification, and settling in a solvent solution. The graphene loading of the coated particles was estimated to be 1.4 weight %.

Disodium rhodizonate (Na₂C₆O₆) was dissolved in water at 80° C. (4 mg/mL) to form an aqueous ution. Then, graphene-embraced NMC-532 particles were dispersed in this solution to form a slurry, which was coated on an Al foil surface and dried to obtain a cathode. A combination of graphene sheets and Na₂C₆O₆ makes a good lithium ion-transporting medium forming dual networks of electron-conducting and lithium ion-conducting pathways.

### EXAMPLE 5

### Sulfonated Polyaniline (S-Pani) as an Example of a Sulfonated Conducting Polymer-Based Lithium Ion-Transporting Medium

The synthetic route for S-PANi is described as follows: In a representative procedure, approximately 0.5 g of emeraldine base (EB) PANi, prepared via the standard method, was mixed in a glass mortar with 2.5 mL of phenylhydrazine. This mixture was pressed with a glass pestle for 5 min and stirred for 1 h to facilitate the reduction of EB to leucoemeraldine base (LEB). The LEB was then diluted with 75 mL of ethyl ether, stirred for 15 min, filtered, washed with three 50-mL portions of ethyl ether, and suction dried. The dried LEB was then sulfonated in 10 mL of fuming sulfuric acid (pre-cooled to approximately 5° C.) for 1 h. The reaction mixture was subsequently introduced into 0.75 L of a 75:25 ice-water mixture to precipitate the S-PANi product. The product was then washed with three 250-mL portions of cold water.

Approximately half of the produced S-PANi was lithiated by reacting S-PANi with LiOH in a methanol-water mixture overnight to obtain Li-S-PANi. The aqueous solution of S-PANi and the solution of Li-S-PANi were then separately added with active material particles (Si particles for the anode and NCA particles for the cathode, respectively) to form separate bottles of slurries. The S-PANi/Si (or Li-S-PANi/Si) slurries and the S-PANi/NCA (or Li-S-PANi/NCA) slurries were then coated onto Cu foil and Al foil to form anode and cathode electrodes, respectively. The S-PANi/Si (or Li-S-PANi/Si) anode, a porous PE/PP separator, and the S-PANi/NCA (or Li-S-PANi/NCA) cathode were then combined and encased in a pouch to form a lithium-ion cell. No additional conductive additive, binder, or electrolyte is required in these cells, which operate exceptionally well as an all-solid-state battery having a high energy density. The battery is flame-resistant and safe since there is no liquid or gel electrolyte. The lithiated versions appear to have a higher-rate capability, delivering a higher capacity at a high charge/discharge rates, likely a manifestation of the higher lithium ion conductivity of Li-S-PANi as compared to S-PANi.

### EXAMPLE 6

### Organic Cathode Active Material (Li₂C₆O₆) as a Lithium Ion-Transporting Medium of a Lithium Metal Battery

In order to synthesize dilithium rhodizonate (Li₂C₆O₆), the rhodizonic acid dihydrate (species 1 in the following scheme) was used as a precursor.

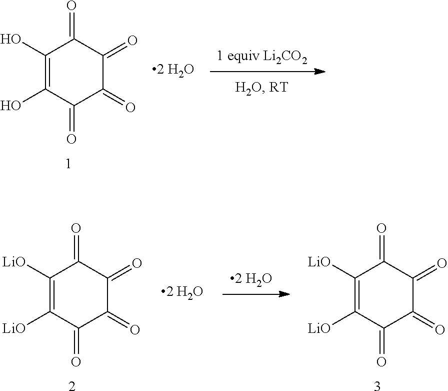

A basic lithium salt, Li₂CO₃ can be used in aqueous media to neutralize both enediolic acid functions. Strictly stoichiometric quantities of both reactants, rhodizonic acid and lithium carbonate, were allowed to react for 10 hours to achieve a yield of 90%. Dilithium rhodizonate (species 2) was readily soluble in water to form an aqueous solution. A small amount of polyethylene oxide, PEO, (corresponding to approximately 2% in the resulting composite cathode electrode) was dissolved in this solution. Particles of carbon-coatedLiCoO2 were then added into this solution to form a slurry, which was coated onto an Al foil and dried to form a cathode layer. Residual water in this layer was removed in a vacuum at 180° C. for 3 hours to obtain the anhydrous version (species 3), mixed with LiCoO₂ particles and bonded by PEO.

It may be noted that the two Li atoms in the formula Li₂C₆O₆ are part of the fixed structure and they do not participate in reversible lithium ion storing and releasing. In an additional experiment, Li₄C₆O₆ was prepared by thermal disproportionation of Li₂C₆O₆; i.e., Li₄C₆O₆ (or Li₄-THQ) was obtained by annealing of dilithium rhodizonate at 400° C. for 1 h under Ar according to the following scheme:

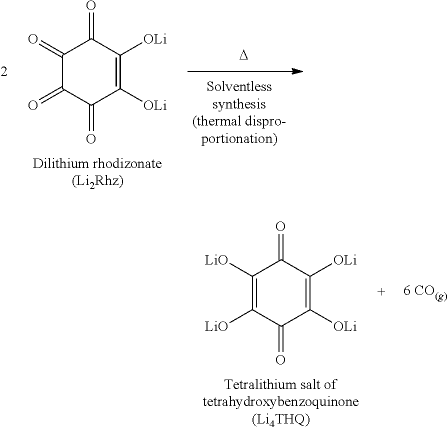

The Li₄C₆O₆ material not only participates in transporting Li⁺ ions, but also serves as a lithium ion reservoir, capable of improving cycling stability of the resulting lithium battery.

### EXAMPLE 7

### Carbon-Encapsulated Tin Oxide Particulates

Tin oxide (SnO₂) nano particles were obtained by the controlled hydrolysis of SnCl₄·5H₂O with NaOH using the following procedure: SnCl₄·5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 m in. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere. SnO₂ particles were then dispersed in a phenolic resin solution and cast onto a glass surface to make a precursor anode layer. This layer was then heat-treated at 300° C. for 2 hours and then at 550° C. for 3 hours to obtain an anode layer containing anode material particles embedded in a carbon matrix.

### EXAMPLE 8

### Preparation of a Metal-free Naphthalocyanine-Coated Cathode Particles

The starting material, 2,11,20,29-Tetra-tert-butyl-2,3-naphthalocyanine (NPc), was purchased from Aldrich. The graphene oxide used was available from Taiwan Graphene Co. NPc-chloroform solution (9.90×10⁻³ mg/mL) was first mixed with GO-chloroform solution with increasing concentrations (from 0 to 1.64×10⁻³ mg/mL), then sonicated for 15 min (NPc/GO ratio being 4/1). Cathode active material particles (V₂O₅) were then added into the above solution to form a slurry. The slurry was then dried in a vacuum over at 50° C. overnight to remove the solvent. The resulting powder was slightly ball-milled to obtain NPc/GO-encapsulated V₂O₅ particles (V₂O₅/NPc ratio=8/2). These particles, along with 3% PVDF binder, were then made into a cathode electrode. A Cu foil-supported lithium metal foil, a PE/PP separator, and this cathode electrode were then combined to make a lithium metal cell.

### EXAMPLE 9

### Preparation of Transition Metal Naphthalocyanine/Graphene Encapsulated Cathode Active Material Particles

Pristine graphene sheets were dispersed (partially dissolved) in NMP with the assistance of ultrasonication. Several cobalt naphthalocyanine (CoPc)/NMP solutions with different CoPc concentrations were also prepared. The graphene/NMP solution and CoPc/NMP solution were then mixed to obtain a precursor encapsulating solution. NMC-622 particles were then added into this NMP solution to make a slurry, which was then spray-dried to form secondary particles (particulates) that contain a core of NMC-622 particles encapsulated by a shell of CoPc/graphene composite. These particulates were then compacted to form a cathode layer.

1. A rechargeable lithium battery comprising an anode, a cathode, a lithium-ion permeable and electrically insulating separator that electrically separates the anode from the cathode, and a first solid-state lithium ion-transporting medium, wherein (i) the first lithium ion-transporting medium and particles of a first cathode active material are combined to form a cathode active material composite layer wherein the cathode active material occupies at least 75% by weight or by volume of the cathode composite layer; (ii) the first lithium ion-transporting medium comprises a material selected from graphite, graphene, carbon, a sulfonated conducting polymer, a phthalocyanine compound, an organic or organometallic cathode or anode active material, or a combination thereof, wherein the organic or organometallic cathode active material is different in composition than the first cathode active material; and (iii) the first lithium ion-transporting medium constitutes a 3D network of both lithium ion-conducting paths and electron-conducting paths in the cathode.

2. The rechargeable lithium battery of claim 1, wherein the cathode composite layer (i) comprises cathode active material particles that are individually encapsulated by the first lithium ion-transporting medium, or (ii) comprises particulates that each contains a plurality of cathode active material particles encapsulated by the first lithium ion-transporting medium.

3. The rechargeable lithium battery of claim 1, wherein the cathode does not contain an additional conductive additive that is different than the graphite, graphene, or carbon and wherein the cathode does not contain an inorganic solid electrolyte, a liquid electrolyte, a polymer gel electrolyte, or a solid polymer electrolyte.

4. The rechargeable lithium battery of claim 1, wherein the sulfonated conducting polymer comprises a sulfonated version of a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a lithiated version thereof, or a combination thereof.

5. The rechargeable lithium battery of claim 1, wherein the phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, a lithiated version thereof, or a combination thereof.

6. The rechargeable lithium battery of claim 1, wherein the organic or organometallic cathode or anode active material is selected from poly(anthraquinonyl sulfide) (PAQS), lithium oxocarbons, oxacarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material based on multiple adjacent carbonyl groups, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, Na₄C₆O₆, Na₂C₆O₆, Na₆C₆O₆, tetralithium 1,2,4,5-benzene etracarboxylate (Li₄C₁₀H₂O₈, Li₄BTC) salt, tetralithium salt of tetrahydroxybenzoquinone (denoted Li₄-THQ), tetralithium salt of dihydroxyterephthalate (Li₄-p-DHT), Emodin (6-methyl1,3,8-trihydroxyanthraquinone), humic acid, dilithium salt of 2,5-(dianilino)terephthalate (denoted Li₂-DAnT), Poly (2,2,6,6-tetramethylpiperdinyloxy4-yl methacrylate) (PTMA), tetralithium 2,5-dihydroxy-1,4-benzenedisulfonate, di-lithium (2,3-dilithium oxy)-terephthalate (denoted Li₄-o-DHT), dilithium terephthalate, conjugated dicarboxylate, or a combination thereof.

7. The rechargeable lithium battery of claim 6, wherein the thioether polymer is selected from Poly[methanetetryl-tetra(thiomethylene)] (PMTTM), Poly(2,4-dithiopentanylene) (PDTP), or Poly(ethene-1,1,2,2-tetrathiol) (PETT), Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB) having a polyphenylene main chain linking thiolane on benzene moieties as pendants, poly[3,4(ethylenedithio)thiophene] (PEDTT) having polythiophene backbone linking cyclo-thiolane on the 3,4-position of the thiophene ring, or a combination thereof.

8. The rechargeable lithium battery of claim 1, further comprising a second solid-state lithium ion-transporting medium, wherein
the second lithium ion-transporting medium and particles of an anode active material are combined to form an anode active material composite layer, wherein the anode active material occupies at least 75% by weight or by volume of the anode composite layer;
the second lithium ion-transporting medium comprises an ion-conducting and electron-conducting material selected from graphite, graphene, carbon, a sulfonated conducting polymer, a phthalocyanine compound, an organic or organometallic cathode or anode active material, or a combination thereof; and
the second lithium ion-transporting medium constitutes a 3D network of both lithium ion-conducting paths and electron-conducting paths in the anode.

9. The rechargeable lithium battery of claim 8, wherein the anode does not contain an additional conductive additive that is different than the graphite, graphene, or carbon and wherein the anode does not contain an inorganic solid electrolyte, a liquid electrolyte, a polymer gel electrolyte, or a solid polymer electrolyte.

10. The rechargeable lithium cell of claim 1, wherein the first lithium ion-transporting medium further comprises a lithium salt dispersed therein.

11. The rechargeable lithium cell of claim 8, wherein the second lithium ion-transporting medium further comprises a lithium salt dispersed therein.

12. The rechargeable lithium cell of claim 1, which is a lithium metal secondary cell, a lithium-ion cell, a lithium-sulfur cell, a lithium-ion sulfur cell, a lithium-selenium cell, or a lithium-air cell.

13. The rechargeable lithium cell of claim 1, wherein the first cathode active material is selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNiₙCo_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO_{2,} 0<p<1), or lithium nickel manganese oxide (LiNi_{q}Mn_{2-q}O₄, 0<q<2).

14. The rechargeable lithium cell of claim 1, wherein the first cathode active material comprises an inorganic material selected from a metal oxide, metal phosphate, metal silicide, metal selenide, transition metal sulfide, or a combination thereof.

15. The cathode active material layer of claim 14, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

16. The cathode active material layer of claim 14, wherein said inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

17. The cathode active material layer of claim 14, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

18. The cathode active material layer of claim 14, wherein said inorganic material is selected from a transition metal dichalcogenide, a transition metal trichalcogenide, or a combination thereof.

19. The cathode active material layer of claim 14, wherein said inorganic material is selected from TiS₂, TaS₂, MoS₂, NbSe₃, MnO₂, CoO₂, an iron oxide, a vanadium oxide, or a combination thereof.

20. The cathode active material layer of claim 14, wherein said inorganic material comprises a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

21. The cathode active material layer of claim 14, wherein said inorganic material is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

22. The cathode active material layer of claim 14, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

23. The rechargeable lithium cell of claim 1, which is a lithium-ion cell wherein the anode comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

24. The rechargeable lithium cell of claim 1, which is a lithium metal secondary cell wherein the anode contains an anode current collector and initially does not contain lithium when the battery cell is made and prior to a first charge.

25. A method of producing the rechargeable lithium cell of claim 1, the method comprising:
a) Preparing an anode, a cathode, a lithium-ion permeable and electrically insulating separator, wherein the cathode comprises a composite layer comprising coated particles of a first cathode active material, wherein the coated particles each comprise individual or a plurality of primary particles of the first cathode active material that are coated with or encapsulated by a first lithium ion-transporting medium comprising a material selected from graphite, graphene, carbon, a sulfonated conducting polymer, a phthalocyanine compound, an organic or organometallic cathode or anode active material, or a combination thereof, wherein the first lithium ion-transporting medium constitutes a 3D network of both lithium ion-conducting paths and electron-conducting paths in the cathode; and
b) combining the anode, the separator, the cathode, and a protective housing into the battery

26. The method of claim 25, wherein the anode comprises a composite layer comprising coated particles of an anode active material, wherein the coated particles each comprise individual or a plurality of anode active material primary particles that are coated with or encapsulated by a second lithium ion-transporting medium comprising a material selected from graphite, graphene, carbon, a sulfonated conducting polymer, a phthalocyanine compound, an organic or organometallic cathode active material, or a combination thereof, wherein the second lithium ion-transporting medium constitutes a 3D network of both lithium ion-conducting paths and electron-conducting paths in the anode.

27. The rechargeable lithium battery of claim 8, wherein the anode active material layer is supported by an anode current collector, wherein the limitation of the anode active material occupying at least 75% by weight or by volume of the anode composite layer does not count the anode current collector weight or volume.
